(19) United States
(12) Patent Application Publication
(10) Pub. No.: US 2011/0163753 A1
(43) Pub. Date: Jul. 7, 2011

(54) Sensor system and method for detection of fluids with a certain material composition

(76) Inventors: Nikola Lalic, St. Valentin (AT); Michael Naderhirn, Linz (AT); Gerald Rauecker, St. Valentin (AT)

(21) Appl. No.: 12/928,932

(22) Filed: Dec. 21, 2010

(30) Foreign Application Priority Data
Dec. 21, 2009 (AT) A2020/2009

(51) Int. Cl. G01N 27/62

(52) U.S. Cl. 324/459

(57) ABSTRACT

A method for detecting fluids having a certain material composition is disclosed. The method comprises at least the following steps: ionizing the fluid using at least one high-voltage electrode coupled to a high-voltage source, such that the high voltage electrode generates charge carriers and emits these charge carriers which are at least partially re-collected by measurement electrodes; measuring electrical quantities at the plurality of measurement electrodes being spaced apart from each other as well as from the high voltage electrode; determining the spatial distribution of the measured electrical quantities; comparing the spatial distribution of the measured electrical quantities with at least one reference distribution; providing an output signal responsive to the comparison and indicating the presence of a fluid component and/or the concentration of the fluid component in the fluid.

### TECHNICAL FIELD

The invention relates to a sensor arrangement and a method for detecting fluids having a certain material composition, in particular for detecting certain gases flowing through a flow channel as well as for measuring the gas flow velocity within the duct.

### BACKGROUND

A flow sensor for measuring the amount of air ingested by a combustion engine is known from publication G. W. Malaczynski, T. Schroeder: “An Ion-Drag Air Mass-Flow Sensor for Automotive Applications”, In: IEEE Trans. on Industry Applications, Vol. 28, No. 2, March 1992.

Such a sensor is based on the principle that the spatial distribution on ions and thus the position dependent current density within an ionized gas is shifted by the motion (the flow) of the gas. This ion distribution depends on the mobility of the ions which, in turn, is a characteristic property of the ionized atoms of the respective substance (e.g. gas mixture). Therefore a different material composition of fluids results in different ion distributions.

For various applications in industrial process measurement technology (e.g. in the exhaust gas recirculation system of a combustion engine) it is desirable to determine the material composition of the flowing fluids or at least to detect fluids having a certain material composition besides measuring the flow velocity.

There is a general need for a sensor arrangement and, respectively, for a method for detecting fluids having a certain material composition.

### SUMMARY

A method for detecting fluids having a certain material composition is disclosed. The method comprises at least the following steps: Ionizing the fluid using at least one high-voltage electrode coupled to a high-voltage source, such that the high voltage electrode generates charge carriers and emits these charge carriers which are at least partially re-collected by measurement electrodes; measuring electrical quantities at the plurality of measurement electrodes being spaced apart from each other as well as from the high voltage electrode; determining the spatial distribution of the measured electrical quantities; comparing the spatial distribution of the measured electrical quantities with at least one reference distribution; providing an output signal responsive to the comparison and indicating the presence of a fluid component and/or the concentration of the fluid component in the fluid.

The method allows for an easy detection or an easy distinction of different fluids or fluid compositions (e.g. gas mixtures) within a flow channel. Further, flow velocities can be determined using such method.

The following figures and the further description is to help to better understand the invention. The elements in the figures are not necessarily to be understood as limiting. Emphasis is rather set in illustrating the principle of the invention. In the figures like reference symbols denote equal or similar components or signals with equal or similar meaning. In the figures:

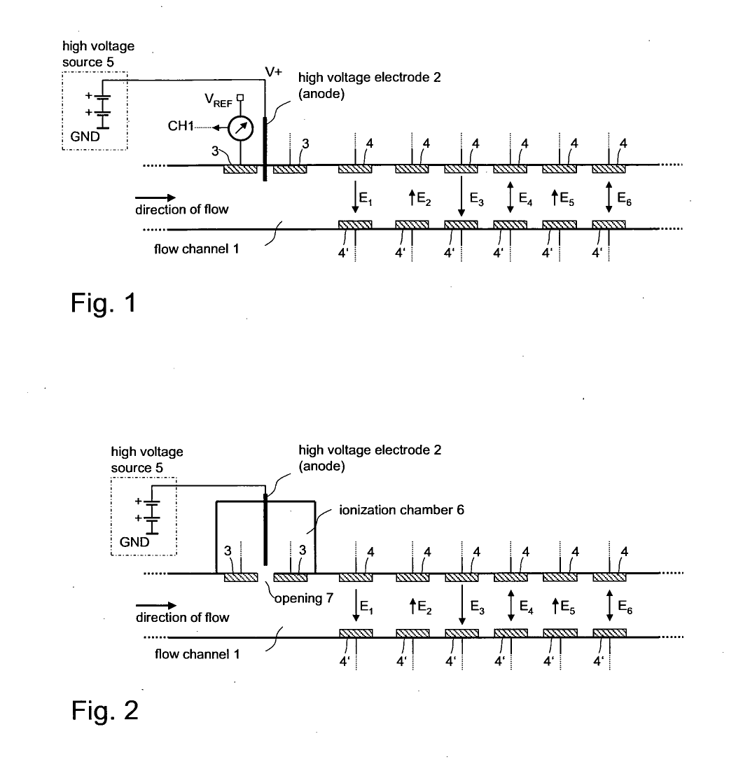

FIG. 1 is a schematical drawing of a longitudinal section of a sensor arrangement in accordance with one example of the invention, the sensor arrangement including a high voltage source and a plurality of measurement electrodes which are arranged alongside the longitudinal axis of the flow channel in the direction of the flow;

FIG. 2 is a schematical drawing of a sensor arrangement in accordance with a further example of the invention similar to the example FIG. 1;

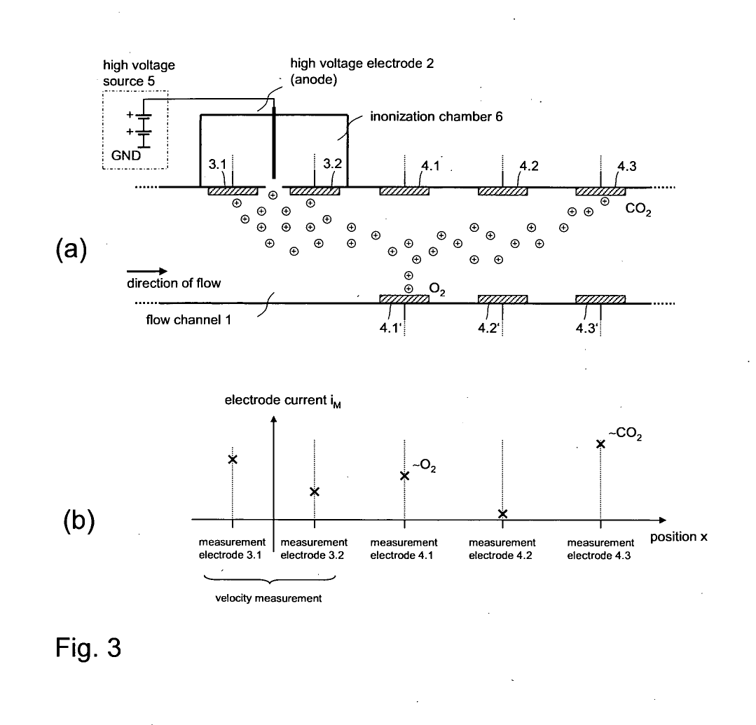

FIG. 3 is a schematical drawing and a diagram for illustrating the function of the example of FIG. 2;

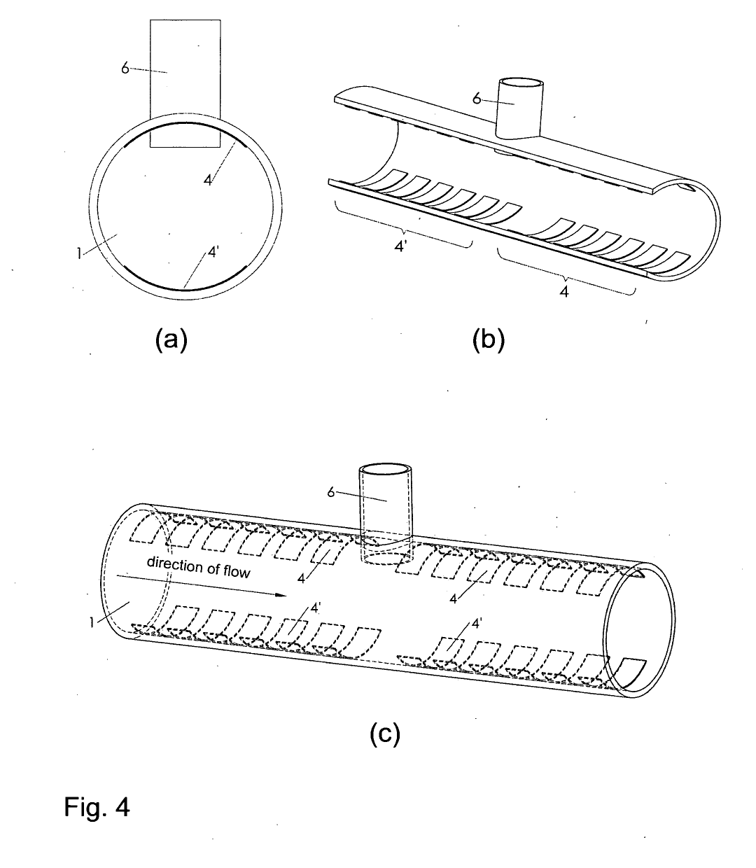

FIG. 4 is a perspective view of the sensor arrangement of FIG. 1;

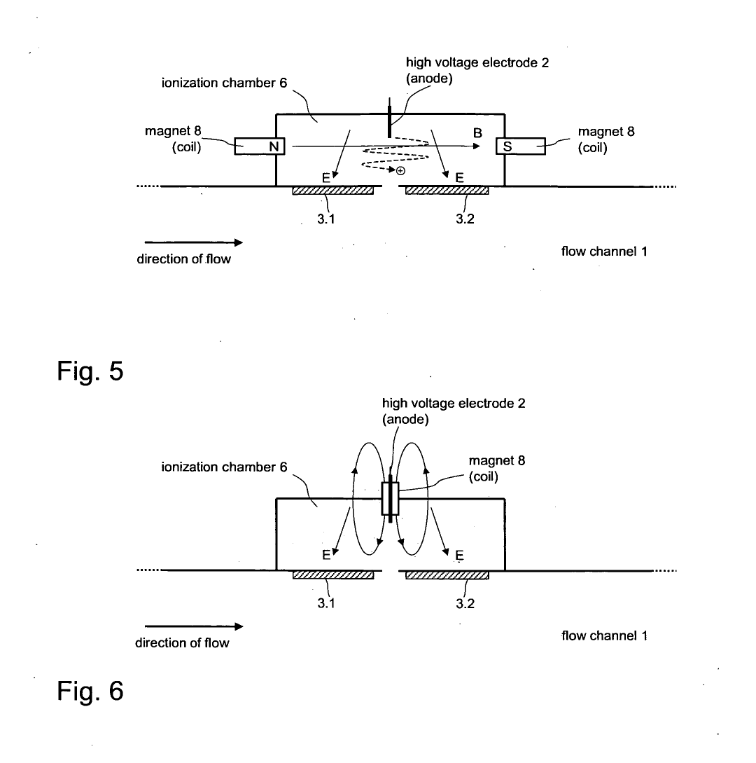

FIG. 5 is an alternative exemplary embodiment of a high-voltage electrode in the sensor arrangement of FIG. 2;

FIG. 6 is a further exemplary embodiment of the high-voltage electrode in the sensor arrangement of FIG. 2;

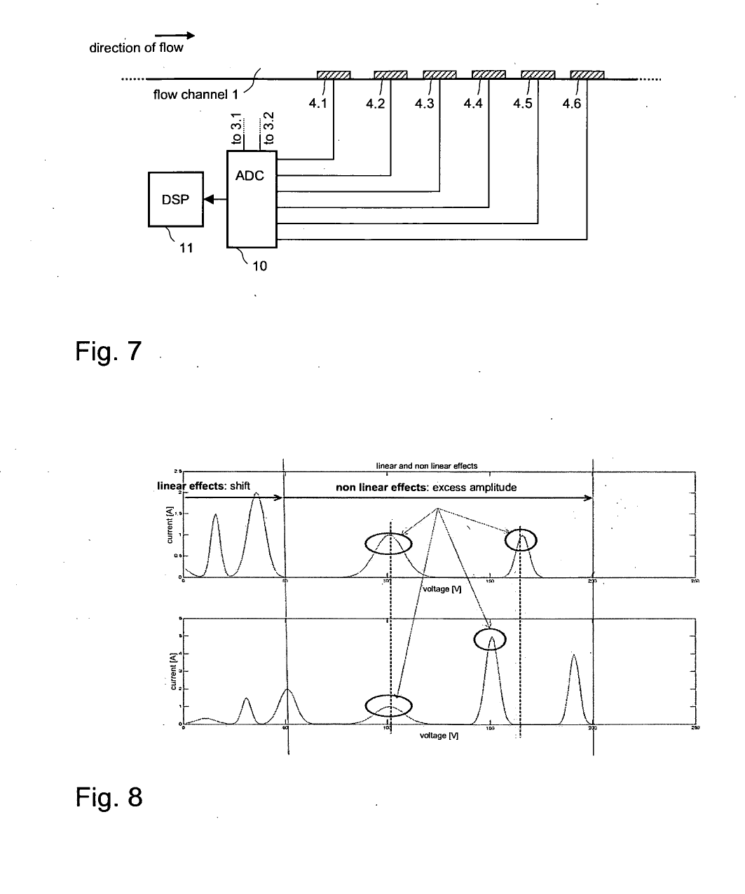

FIG. 7 is a schematical drawing of the measurement and signal processing system for the sensor arrangement in accordance with the examples of FIGS. 1 to 6; and

FIG. 8 is an exemplary diagram of the obtained measurement data.

### DETAILED DESCRIPTION

FIG. 1 illustrates a side view of a sensor arrangement in accordance with one example of the invention including a flow channel 1, a high voltage electrode 2 arranged therein and coupled to a high voltage source 5 and several measurement electrodes 3 and 4. The flow channel 1 may be, for example, a pipe or a duct, through which the considered fluid is flowing. The direction of the flow is indicated by an arrow. A flow channel in the sense of this disclosure does not necessarily need to have an closed cross section, but can rather be formed by a plane alongside which the considered fluid is flowing. Irrespective of the shape of the cross section of the flow channel the average direction of the flow points alongside a longitudinal axis of the flow channel 1, i.e. the vector representing the average flow velocity has the same orientation as a longitudinal axis of the flow channel 1.

The high voltage electrode 2 is arranged at the inner surface of the flow channel 1: In accordance with? the example illustrated in FIG. 1 the high voltage electrode 2 is inserted via a (sealed) aperture in the channel wall. The voltage V+ (DC or AC) applied to the high voltage electrode is high enough to at least partially ionize the flowing fluid such that it becomes conductive, wherein the voltage V+ is genererated by a high voltage source 5. Dependent on the application the voltage applied to the high voltage electrode may amount to several kilovolts. In the illustrated example the high voltage electrode 2 extends only little into the flow channel 1 in order to not affect the flow (i.e. the flow profile). The electrode 2 may also be formed to be flat and close fitting to the inner surface of the channel. Dependent on the application also a plurality of high voltage electrodes 2 may be arranged within the flow channel 1. Different exemplary embodiments of the high voltage electrodes are illustrated in FIGS. 2, 5 and 6.

On both sides (upstream and downstream) of the high voltage electrode 2 a plurality of measurement electrodes 3 and 4 may be arranged in the flow channel 1. In the example illustrated in FIG. 1, a measurement electrode 3 is arranged on both sides (upstream and downstream). Additionally, further measurement electrodes 4 are arranged downstream of the high voltage electrode 2, namely on both, on the same side of the flow channel as the high voltage electrode as well as on the side opposing the high voltage electrode 2.

The measurement electrodes may, for example, be formed to be flat and fitted to the inner surface of the flow channel 1 in order to not affect the flow. In case of a flow channel having a ring-shaped cross section (pipe as flow channel) the measurement electrodes 3, 4 may also be flat ring segments fitted to the inner surface of the flow channel 1 at different positions in the flow channel (pipe) in a longitudinal direction as well as in a peripheral direction. In accordance with the present example a further measurement electrode 4′ is associated with each measurement electrode 4. For example, two corresponding measurement electrodes 4, 4′ may be arranged on opposing sides of the flow channel.

An electrical quantity such as, for example, an electrode current i_{M} may be measured at each measurement electrodes 3, 4. In FIG. 1 this is sketched by the amperemeter 12 connected with a measurement electrode 3. Further, a defined potential (e.g. a reference potential V_{REF} or a ground potential GND) may be applied to the measurement electrodes 3, 4. In the example of FIG. 1 a defined voltage is applied to each pair 4, 4′ of measurement electrode resulting in a respective electrical field (E-field E₁, E₂, E₃, E₄, E₅, E₆) between two associated measurement electrodes 4, 4′. The material composition of the flowing fluid as well as the flow velocity (or the volume flow rate or the mass flow rate) can be derived from the electrical quantities (e.g. from the electrode currents i_{M}) measured at the measurement electrodes. The mode of operation of the sensor arrangement illustrated in FIG. 1 is discussed in more detail further below with reference to FIG. 3.

The term “material composition” of a fluid is understood as the molecular or, respectively, the atomic composition of a fluid composed of different fluidic components, in particular a gas mixture composed of different gas components (in the case of, for example, air this components would be essentially nitrogen, oxygen, argon, water vapor and carbon dioxide). The detection of fluids having a certain material composition does not require the detection of only individual components (it does particularly not require to detect solid particles dissolved in the fluid or liquid droplets present in a gas) it rather requires the identification of the fluid (e.g. of a gas mixture) having an arbitrary molecular or atomic composition.

The example of a sensor arrangement illustrated in FIG. 2 corresponds—except the positioning of the high voltage electrode 2—to the example of FIG. 1. In this example the high voltage electrode 2 (anode) does not extend into the flow channel 1, but is rather arranged within an ionization chamber 6 which is connected with the flow channel 1 via an aperture 7. On both sides (upstream and downstream) of the aperture 7 measurement electrodes 3 are arranged on the inner surface of the flow channel 1 similar to the example of FIG. 1. Due to the high voltage V+ applied to the high voltage electrode 2 the fluid in the ionization chamber is ionized and thus conductive. The charge carriers (ions) are correspondingly accelerated and enter the flow channel 1, where they recombine with respectively complementary charge carriers (electrons) at the measurement electrodes 3 and 4 what leads to a measureable electrode current i_{M} in the measurement electrodes 3 and 4. Due to the arrangement of the high voltage electrode (anode) in the ionization chamber 6 the electrode is protected from massive particle bombardment and the resulting wear. Further exemplary embodiments of the anode arrangements in the ionization chamber are illustrated in FIGS. 5 and 6.

The basic mode of operation of the above-discussed sensor arrangement for detecting fluids having a certain material composition and for measuring the flow velocity is explained below with reference to FIG. 3.

A part of the sensor arrangement of FIG. 2 is illustrated in FIG. 3a at a magnified scale. At first only the measurement electrodes 4 and 4′ are considered. The three pairs of electrodes depicted in the present example are labeled as 4.1, 4.1′, 4.2, 4.2′ and 4.3, 4.3′ (short: 4.x, 4.x′). The measurement electrodes 3.1 and 3.2 are arranged (in the direction of the flow) symmetrically or with respect to the aperture 7 (or to the high voltage electrode 2 respectively) and approximately have ground potential (0 V) or another reference potential (e.g. V_{REF}). With respect to the potential of the measurement electrodes 3.1, 3.2 the voltage V+ of the high voltage electrode is that high that the fluid is ionized, and ions are emitted into the flow channel and thus into the fluid flow through the aperture 7. The measurement electrodes 4.x, 4.x′ are also at a low potential as compared to the high voltage electrode 2. Due to the resulting potential gradient t (i.e. the electrical field) between the high voltage electrode 2 and the measurement electrodes 4.x, 4.x′ as well as due to the flow velocity of the fluid the ions are conveyed to the measurement electrodes 4.x, 4.x′, where they recombine with charge carriers (e.g. electrons) having opposite charge as the charge of the ions thus resulting in an electrode current i_{M} in the respective electrode.

The magnitude of the electrode current i_{M} depends on the position of the considered measurement electrode 4.x in the longitudinal direction (direction of the flow) of the flow channel 1. Having a plurality of measurement electrodes 4.x arranged along the flow within the flow channel an electrode current i_{M}(x), which depends on the position x along the longitudinal direction of the flow channel 1, can be determined by measuring the individual electrode currents i_{M}, wherein the function i_{M}(x) is spatially discrete, i.e. a current value i_{M}(x) can only be obtained at that position x where a measurement electrode 4.x is located in the flow channel 1.

The position dependent current distribution i_{M}(x), such as the position of the maxima and the minima, is characteristic for a certain material composition of the fluid. By comparing with reference curves which represent known material fluid compositions, it can be detected using the measured electrode currents i_{M}(x) whether the flowing fluid is a certain known fluid. When the material components are known (e.g. a mixture of O₂ and CO₂) the ratio of components may be determined from the measured position dependent current distribution (e.g. from the ratio of certain current maxima).

The physical relations are relatively complex and may only be determined by means of simulation or, respectively, by means of reference measurements. A simple model for explaining the mode of operation will be discussed in the following with reference to FIG. 3, wherein for the sake of simplicity it is assumed, as an example, that the fluid to be examined is a gas mixture composed of two components, namely oxygen (O₂, molar mass: 32 g/mol) and carbon dioxide (CO₂, molar mass: approximately 44 g/mol). The ratio between the molar masses of the individual material components (which is 44/32=1,375 in the present example) also defines the ratio between the drift velocities of the ions which allows for separating the ions of the individual material components (O₂ and CO₂). That is, ions of different material components recombine at different measurement electrodes 4.x and the resulting measurement electrode current i_{M}(x) at a certain position x along the longitudinal direction of the flow channel 1 represents the amount of the respective component in the fluid. In the example of FIG. 3a oxygen ions preferably recombine at the measurement electrode 4.1′ and the carbon dioxides ions at the measurement electrode 4.3, whereas at the electrode pair 4.2, 4.2′ no or only few ions recombine. As a result the current distribution i_{M}(x) illustrated in FIG. 3b is obtained, whereby at the spatial coordinates of the measurement electrode 4.1 and 4.3 one respective local current maximum (caused by the O₂ and CO₂ ions, respectively) and at the spatial coordinate of the measurement electrode 4.2 a local minimum can be observed. The position of the maxima is characteristic for the material component itself and the mixture ratio can be deducted from the ratio of the maxima. The measurement and the detection, respectively, work the better, the higher the spacial resolution of the arrangement is. Nevertheless it is necessary (but, however, not unavoidable) in many applications to calibrate the sensor arrangement using measurements with fluids having a known material composition as a reference, that is, a measurement usually includes a comparison with a known reference current distribution.

The quality of the measurement results, i.e. the capability to distinguish different fluid components in qualitative and quantitative terms may be improved by applying defined reference potentials to the measurements electrodes 4.x, 4.x′. In the examples of FIGS. 1 to 3 a defined voltage (AC or DC) is applied between each pair of opposing measurement electrodes (4.1 and 4.1′, 4.2 and 4.2′, 4.3 and 4.3′, etc.) which results in a respective electrical field which is directed transversely to the longitudinal direction of the fluid channel (and thus to the flow direction of the fluid). In FIGS. 1 and 2 this situation is indicated by the arrows labeled E₁, E₂, . . . E₆, which illustrates the orientation of the respective electrical field (a double arrow symbolizes an alternating field). The measurement electrodes 4.x′ are thereby at a constant reference potential, e.g. ground GND. The current i_{M} flowing through the measurement electrodes 4.x is measured.

The magnitude of the voltages and, respectively, of the resulting transverse electrical fields E₁, E₂, . . . , E₆ is determined e.g. experimentally. For a known fluid having different defined material constituent components the strength of the respective electrical field is varied such that a sufficient good “separation” of the individual fluid components is achieved, i.e. such that a position dependent current distribution at the measurement electrodes 4.x exhibits distinctive local maxima each of which can be assigned to one fluid component and whose magnitude represents the concentration (the relative fraction) of the component in the fluid.

For example, the sensor arrangement is adjusted to a gas mixture composed of nitrogen (N), oxygen (O₂) and carbon dioxide (CO₂) wherein the ratio of components is known. The transverse electrical fields E₁, E₂, etc. are adjusted such that the position dependent current i_{M}(x) at the measurement electrodes 4.x exhibits three local maxima, e.g. one maximum representing the nitrogen at the position x₁, one maximum representing the oxygen at the position x₂, and one maximum representing the carbon dioxide at the position x₃. The ratio i_{M}(x₁)/i_{M}(x₂)/i_{M}(x₃) is a measure for the ratio of mixture of the three fluid components. When the ratio of components changes then the peak magnitude of the maxima i_{M}(x₁), i_{M}(x₂) and i_{M}(x₃) changes correspondingly. For a measurement of the concentration of a gas component in quantitave termins the peak magnitude of the respective maximum is to be compared with the reference maximum of a reference current distribution i_{M,REF}(X) which is determined using a test fluid with a known composition of gas components. The adjustment of the above-mentioned transverse electrical fields (E₁, E₂, etc.), which are adjusted by applying voltages at the measurement electrodes 4.x, 4.x′, are practically a “key” which has to be known for a measurement. That is, when making a reference measurement for determining the reference current distribution i_{M,REF}(x) and when making a measurement with unknown fluid composition the same “key” has to be used (that is, the same transverse electrical fields have to be applied) so as to allow for a reasonable measurement.

As an alternative to the electrical fields transverse to the flow direction magnetic fields may be applied and aligned such that the resulting (Lorentz-) force exerted on the ions is effective in the direction of the measurement electrodes (i.e. magnetic field snd flow direction define a plane and parallel thereto the measurement electrodes are arranged).

FIG. 4 includes schematic drawings of the measurement arrangement of FIG. 2 in different views. FIG. 4a illustrates a view in the direction of the flow. FIG. 4b is a perspective sectional view and FIG. 4c is a perspective illustration of a transparent flow channel 1. The ionization chamber with the two measurement electrodes 3.1 and 3.2 for measuring velocity is of a cylindrical shape in the present example. The arrangement of the measurement electrodes 4 is symmetrically with respect to the high voltage electrode which allows for a measurement of the composition of the fluid regardless of the flow direction of the fluid. The velocity measurement may be performed in a known manner (see introduction).

FIGS. 5 and 6 illustrate further examples or the arrangement of a high voltage electrode 2 (anode) within the ionization chamber 6 in addition to the exemplary embodiment of FIG. 2. Both arrangements (in FIGS. 5 and 6) essentially correspond to the arrangement of FIG. 2 wherein additionally a magnet 8 (e.g. permanent magnet, Helmholtz coil, etc.) is arranged in the chamber 6. In the example illustrated in FIG. 5 the magnets 8 are arranged such that the magnetic field lines are aligned essentially perpendicular to the elongated (e.g. needle-shaped) high voltage electrode. The magnetic field lines penetrate the ionized fluid about 2 mm below of the tip of the high voltage electrode 2 and are essentially perpendicular to the electrical field (see schematical drawing of FIG. 5) which essentially is vertically aligned and generated by the high voltage electrode. Thus, the ions are pushed to a circular trajectory and the path of the ions is lengthend before the enter the flow channel 2 via the opening 7. The arrangement of FIG. 6 operates in a similar way. However, in the example of FIG. 6 a coil is arranged parallel to the needle-shaped high voltage electrode. In both cases the current through the high voltage electrode also flows through the coils. Due to the additional magnetic field in a direction transverse to the high voltage electrode 2 a (Lorentz) force is exerted on the ions. The force lengthens the distance which the ions have to cover. The Lorentz force effects a precession movement of the ions around the magnetic field lines. The particles are moved out of the ionization chamber by diffusion and particle collisions (natural losses). The effect of the magnetic field is based on principle denoted as “magnetic bottle”. The magnetic field amplifies the ionization and the intensity of the resulting measurement signals i_{M}(x). The amplification is achieved by directing the emitter current also through the coils which generate the magnetic field. The higher the magnetic field, the higher the emitter current. By means of this feedback, the current is additionally amplified until a stationary state is achieved.

In FIG. 7, the measurement data acquisition is sketched for the sensor arrangement of FIGS. 1 and 2. Each measurement electrode is connected to a measurement data acquisition system (ADC 10, signal processor 11) which is configured to measure, in each channel, the current through the respective measurement electrode 3.1, 3.2, 4.x and, if applicable, to regulate the electrode voltage as well as to store the measured data for further processing (digital signal processor 11).

In accordance with one example of the invention the method for detecting fluids having a certain material composition includes:

(1) Using a high voltage source 5 a high voltage is applied to a high voltage electrode 2, the voltage being that high that the flowing fluid is at least partially ionized and charge carriers are generated in the high voltage electrode 2, are emitted, and can at least partially be re-collected by the measurement electrodes 3, 4. The charge carriers emitted by the high voltage electrode 2 forms the emitter current.

(2) At the individual measurement electrodes 3, 4, which are arranged at a certain distance from each other, electrical quantities such as current, voltage, conductivity, etc. are measured (in the examples discussed above the current i_{M} is measured).

(3) The electrical quantities measured at the individual measurement electrodes 4, 5 arranged on different positions within the flow channel exhibit a certain spatial distribution i_{M}(x). This spatial distribution of the measured quantities is determined (e.g. electrode current vs. position).

(4) The determined spatial distribution of the measured electrical quantities is compared with at least one stored reference distribution—dependent on the application also with several reference distributions. A reference distribution may be, for example, characteristic for a certain material composition of the fluid.

(5) Dependent on the comparison, an output signal is provided which indicates, whether the spatial distribution of the measured electrical quantities at least partially corresponds with a reference distribution.

The following come into consideration as fluids: exhaust gases from combustion processes (e.g. in a combustion engine), as well as process gases from industrial facilities, circulating air from clean rooms, etc. In case of a combustion process the type of the combusted fuel (e.g. gasolines, diesel oils, kerosene, etc.) may result in a different material composition of the exhausted gases generated by the combustion process. Provided that the above mentioned characteristic distribution of the electrical quantities measured at the measurement electrodes 3, 4 are known for the respective exhaust gas (e.g. exhaust gasses from diesel and petrol engines) the combustion process producing the respective exhaust gas may be detected by means of the above described sensor arrangement by comparing the currently measured distribution with a known reference distribution. For example, mixtures having a certain fraction of e.g. nitrogen (N₂) and/or oxygen (O₂) may be detected in such a way.

Dependent on the (measured) flow velocity the above-mentioned distribution may be shifted for a certain fluid of a given material composition. By comparing the measured distribution with a known reference distribution obtained at a certain flow velocity (e.g. at the static fluid) the flow velocity may be deducted, too. Each stored reference distribution is thus associated with a known flow velocity (e.g. zero). The reference distributions are determined e.g. empirically.

In case of an equal spacing of the measurement electrodes 3 and 4 along a line parallel to the longitudinal axis of the flow channel 1 the distribution of the measured electrical quantities corresponds to a (sampled) function which describes the relationship between the respective quantity (current and/or voltage) and a spatial coordinate. The spatial coordinate thereby represents a position on the longitudinal axis of the flow channel. The measurement electrodes 3 and 4, respectively, may be arranged symmetrically with respect to the high voltage electrodes (however, they do not have to).

Additionally or alternatively, an average of the measurement values at the measurement electrodes may be formed. When forming an average also only a subset of the measurement electrodes may be considered, e.g. only that electrodes 3, 4 which are arranged upstream to the high voltage electrode 2 and/or only that arranged downstream to the high voltage electrode 2. Dependent on the determined voltage or current average or, dependent on the individual average values over a subset of the electrodes, the flow velocity may be deducted.

For the detection of a fluid of a certain material composition the “pattern” i.e. the shape) of the determined distribution rather plays a role, particularly the number of the extrema (maxima and minima) in the measured spatial distribution of the signal amplitudes and their relative position to each other are characteristic. If, when comparing the currently measured distribution with a reference distribution, only the position and the number of the (local) maxima and minima, which exceed and fall below, respectively, a certain threshold, are considered, then possibly occurring non-linear effects (e.g. non uniform amplitude variations along the spatial coordinate) may be masked.

Further, when comparing the measured spatial distribution with a reference distribution, a spatial scaling and/or displacement of the measured spatial distribution with respect to the reference distribution may be considered. Spatial scaling is to be understood such that e.g. the spatial distances of the maxima and, respectively, the minima in the measured distribution may vary dependent on the flow velocity of the fluid. These non-linear effects are illustrated in FIG. 8 in an exemplary manner.

While the invention has been described by means of an exemplary embodiment, the invention can additionally be modified within the spirit and the scope of this disclosure. The present application shall thus cover numerous variants, applications, and adaptions of the invention using its fundamental principles. Further, the present application intends to cover such deviations from the present disclosure which are known or common practise in the art on which the present invention is based. The invention is not limited to the above indicated details but may be modified in accordance with independent claims.

1. A method for detecting fluids having a certain material composition, the method comprising:
ionizing the fluids using at least one high voltage electrode connected to a high voltage source such that the high voltage electrode generates and emits charge carriers which are at least partially re-collected by measurement electrodes;
measuring electrical quantities at a plurality measurement electrodes which are spaced apart from each other as well as from the high voltage electrode;
determining the spatial distribution of the measured electrical quantities;
comparing the spatial distribution of the measured electrical quantities with at least one reference distribution that characterizes the fluid having a certain material composition; and
providing an output signal which, dependent on the comparison, indicates at least one of: a presence of a fluid component or a concentration of the fluid component in the fluid.

2. The method according to claim 1, wherein the measured electrical quantities are at least one of: currents or voltages.

3. The method according to claim 1, wherein a group of measurement electrodes are arranged in one line along a longitudinal direction of a flow channel in which the fluid flows.

4. The method according to claim 1, further comprising:
determining an average of the electrical quantities measured at the measurement electrodes to obtain an average spatial distribution of the measured electrical quantities; and
determining an output signal representing the flow velocity of the fluid dependent on the average.

5. The method according to claim 1, further comprising:
determining a shift between the spatial distribution of the measured electrical quantities and the at least one reference distribution; and
determining an output signal representing the flow velocity of the fluid dependent on the shift.

6. The method according to claim 1, further comprising:
determining an average from a part of a spatial distribution of the measured electrical quantities;
determining a shift between the spatial distribution of the measured electrical quantities and the at least one reference distribution; and
determining an output signal representing the flow velocity of the fluid dependent on the average and the shift.

7. The method according to claim 1, wherein at least one of: (i) a spatial scaling or (ii) a shift of the measured spatial distribution with respect to the reference distribution is considered in the comparison of the measured spatial distribution with the reference distribution.

8. The method according to claim 1, wherein, in the spatial distribution of the measured electrical quantities, is a position dependent current distribution at the measurement electrodes along the flow channel and wherein local maxima of the current distribution are determined.

9. The method according to claim 8, wherein a component of the fluid flowing in the flow channel is identified by the position of a local maximum.

10. The method according to claim 8, wherein the concentration of a fluid component of the fluid flowing in the flow channel is determined using the magnitude of a local maximum and the magnitude of a corresponding local maximum in a reference distribution.

11. A sensor arrangement for detecting fluids having a certain material composition, the sensor arrangement comprising:
a flow channel for conducting a fluid flow, the flow channel being at least partially confined by a channel wall;
at least one high voltage electrode arranged at the inner surface of the channel wall for generating charge carriers forming an emitter current;
a plurality of measurement electrodes spaced part from each other and arranged in the flow channel for collecting the charge carriers;
at least one high voltage source configured to provide a high voltage for the at least one high voltage electrode, the voltage being that high that the fluid in the flow channel is at least partially ionized; and
a measurement and evaluation unit electrically connected to the measurement electrodes and configured to measure electrical quantities at the measurement electrodes, to determine the spatial distribution of the measured electrical quantities, to compare this with at least one reference distribution, and to provide an output signal which indicates whether the spatial distribution of the measured electrical quantities corresponds at least partially with a reference distribution.

12. The sensor arrangement according to claim 11, wherein the measurement electrodes are arranged at an inner surface of the flow channel along a longitudinal direction of a channel in which the fluid flows.

13. The sensor arrangement according to claim 12, wherein groups of measurement electrodes are arranged according to at least one of: (i) next to the high voltage electrode or (ii) opposite to the high voltage electrode in the flow channel with respect to the longitudinal direction.

14. The sensor arrangement according to claim 11, wherein a plurality of high voltage electrodes are arranged alongside the circumference of the flow channel.

15. The sensor arrangement according to claim 11, wherein a plurality of high voltage electrodes are arranged along a longitudinal direction of the flow channel.

16. The sensor arrangement according to claim 1, wherein a defined electrical potential is applied to at least one of the measurement electrodes.

17. The sensor arrangement according to claim 16, wherein a defined electrical potential is applied to at least one of the measurement electrodes, and at each pair of opposingly arranged measurement electrodes a predeterminable electrical AC or DC voltage is applied.
